(19) United States
(12) Patent Application Publication
(10) Pub. No.: US 2011/0205929 A1
(43) Pub. Date: Aug. 25, 2011

(54) METHOD OF OPTIMISING BANDWIDTH ALLOCATION IN A WIRELESS COMMUNICATION NETWORK

(75) Inventors: Quee Seng Tony Quek, Singapore (SG); Zhongding Lei, Singapore (SG); Sumei Sun, Singapore (SG)

(73) Assignee: AGENCY FOR SCIENCE, TECHNOLOGY AND RESEARCH, Singapore (SG)

(21) Appl. No.: 13/126,674

(22) PCT Filed: Oct. 21, 2009
(86) PCT No.: PCT/SG09/00391

§ 371 Date: Apr. 28, 2011

(30) Foreign Application Priority Data
Oct. 21, 2009 (WO) PCTSG2009000391

(51) Int. Cl. H04W 72/04; H04L 12/26

(52) U.S. Cl. 370/252; 370/329; 370/330

(57) ABSTRACT

A method for communication (400) comprising partitioning a plurality of user equipment (UE) within a cell of a base station (BS) into a cell-edge user group or a cell-interior user group (402), determining a bandwidth allocation for the cell-edge user group that is orthogonal with cell-edge user groups of one or more neighbouring base stations, determining a frequency allocation for each UE in the cell-edge user group that is orthogonal with cell-edge user groups of one or more neighbouring base stations, determining a minimum transmit power for the cell-edge user group based on the bandwidth allocation and frequency allocation for the cell-edge user group and a predetermined minimum target rate (404), determining a transmit power for each UE in the cell-interior user group based on the determined transmit power for the cell-edge user group, and determining a frequency allocation for each UE of the cell-interior user group based on the determined transmit power for the cell-edge group and a weighting factor (408).

### FIELD OF THE INVENTION

This invention relates to a method of communication, a base station, a communication network, a user equipment and an integrated circuit, and relates particularly though not solely to efficient frequency reuse to minimise inter-cell interference in a cellular communication network.

### BACKGROUND

The following abbreviations may be used in this specification:
OFDMA Orthogonal Frequency Division Multiple Access
3GPP 3rd Generation Partnership Project
MIMO Multiple-Input and Multiple-Output
LTE Long Term Evolution 3GPP pre 4G standard eg: E-UTRA (Release 8)
WiMAX Worldwide Interoperability for Microwave Access
SINR Signal to Interference and Noise Ratio
BS Base Station
UE User Equipment
ICI Inter-Cell Interference
NB Node B i.e. a termination between the air interface and the carrier network, eg: base station
SCH Synchronisation Channel
q the fraction of the system bandwidth reserved as the cell-edge band
p frequency reuse factor in the cell-edge band
K number of UE in each BS
k user index
n, m in cell indexes
[symbol] _{I} cell-interior user group of each BS
[symbol] _{E} cell-edge user group of each BS
K_{E}⁽ⁿ⁾ number of cell-edge users in the n-th cell
K_{E}^{(m}^{₁}^{;n)} number of cell-edge users in the mᵢ-th neighbouring cell of the n-th cell, where i is an index such that i=1 . . . 1/p−1 and where the cell edge users of the mᵢ-th cell uses distinct frequency bands from cell edge users of the n-th cell.
Pₘₐₓ maximum total transmission power of a BS
P_{E} total power of the cell-edge user group
P₀ transmission power of a BS
Pₜₕ power threshold value for P_{E}
W total system bandwidth
W_{E} system bandwidth for cell-edge users
W_{I} system bandwidth for cell-interior users
B bandwidth of each subchannel
[symbol] set of subchannel indexes
[symbol] _{E}⁽ⁿ⁾ set of subchannel indexes available for assignment to the [symbol] _{E} of the n-th cell
[symbol] _{I}⁽ⁿ⁾ set of subchannel indexes available for assignment to the [symbol] _{I} of the n-th cell
j subchannel index
[symbol] number of cells
hⱼₖ^{(m)} random channel gain in the subchannel j between the k-th user and the BS in the mth cell,
[symbol] ₘᵢₙ⁽ⁿ⁾ Sum-power-minimization problem for the n-th cell
[symbol] ₘₐₓ⁽ⁿ⁾ Weighted sum-rate-maximization problem for the n-th cell
[symbol] ₘᵤₗₜᵢ Multi-cell weighted-sum-rate-maximization problem
AWGN Additive White Gaussian Noise
N₀ power spectral density of the AWGN,
pⱼ^{(m)} transmission power allocated in the j-th subchannel of the m-th cell
pⱼ⁽ⁿ⁾ transmission power allocated in the j-th subchannel of the n-th cell
Rₘᵢₙ target minimum rate
R_{I,k}⁽ⁿ⁾ instantaneous throughput of the k-th cell-interior user in the n-th cell
R_{E,k}⁽ⁿ⁾ instantaneous throughput of the k-th cell-edge user in the n-th cell
wₖ⁽ⁿ⁾ weighting factor for the k-th UE in the n-th cell
dₜₕ distance threshold for separating the cell-interior and cell-edge user groups
SINRₜₕ instantaneous SINR threshold for separating the cell-interior and cell-edge user groups
S̅I̅N̅R̅ₜₕ average SINR threshold for separating the cell-interior and cell-edge user groups
SINRⱼₖ⁽ⁿ⁾ instantaneous SINR of the k-th user at the j-th subchannel in the n-th cell
xⱼₖ⁽ⁿ⁾ variable indicating a utilisation of a j-th subchannel of a k-th user of the n-th cell
ε path loss exponent
R radius of a cell
dₖ distance between the k-th UE and the BS serving the k-th UE
Jₘᵢₙ minimum number of subchannels allocated to cell-edge users in the [symbol] ₘᵢₙ⁽ⁿ⁾ problem

Wireless or cellular communication systems may use a range of different technologies in order to operate in an efficient and/or effective manner. OFDMA is one of the technologies that will be likely to be adopted by the next generation of cellular systems. In particular, OFDMA has been adopted as the downlink transmission technology by several communication standardisation bodies like 3GPP LTE and IEEE 802.16 Mobile WiMAX. OFDMA is a multicarrier transmission technique, which divides the available spectrum and time resources into a number of multiplexed orthogonal subchannels (or “resource blocks” in the 3GPP context) and numerous subchannels are combined at the receiver to form one high-speed data transmission. Since each subchannel is assigned exclusively to a particular user, there is no intra-cell interference. Moreover, a robust, reliable, and spectrally efficient cellular system may be achieved through efficient resource allocation to exploit multiuser, time, and frequency diversity within each cell. However, should a universal frequency reuse factor of one be used, users may experience interference from other cells and this ICI can significantly reduce the user throughput. Users located at the edge of the cell or at a bad coverage location may experience a low SINR and therefore be susceptible to ICI.

To mitigate the ICI problem, one can exploit efficient resource scheduling algorithms to allocate the subchannels and power so as to minimise the overall system interference level. Such a multi-cell scheduling approach may require a centralised scheduler to solve joint subchannel and power optimisation problems across all the users in their corresponding cells. A large amount of information may thus need to be conveyed to the centralised scheduler. Considering the signalling overhead and the computational complexity of such an optimisation problem, it may be challenging to implement the multi-cell scheduling in practical cellular systems, especially in a mobile environment.

Alternatively, one can employ lower complexity interference coordination schemes that use multiple reuse factors in the same cellular system so as to protect the weak users from ICI. The underlying principle behind reuse partitioning is to lower the received SINR for users that already have more than adequate transmission quality while offering greater ICI protection to those users that require it by restricting time/frequency/power resources in a coordinated way among multiple cells. The aim is to generate an overall SINR distribution that satisfies reception quality constraints while bringing about a general increase in cell throughput.

In traditional frequency reuse schemes, different disjoint subchannel subsets may be assigned to different cells, with subchannel subsets reused at spatially separated locations. This concept exploits the fact that since the signal power falls off with distance, the same frequency spectrum can be reused at spatially separated locations. Contrary to the traditional frequency reuse scheme, fractional frequency reuse schemes allow users in different channel conditions to utilise different reuse factor. Specifically, the whole system bandwidth is divided into two subchannel groups respectively dedicated for cell-interior and cell-edge users. In addition, the subchannels assignment are coordinated such that all cell-interior users share a universal reuse factor, while all the cell-edge users share a reuse factor smaller than one. The fractional frequency reuse schemes can be divided into hard and soft frequency reuse schemes.

In the hard frequency reuse scheme, the cell-edge subchannel group is coordinated among multiple cells such that the cell-edge users within each cell are only allowed to use part of the cell-edge subchannel group. This is equivalent to the conventional frequency reuse concept, except that it is used only on the cell-edge band. Clearly, hard frequency reuse ensures that the cell-edge users are fully protected at the expense of an inefficient usage of system bandwidth.

On the other hand, the soft frequency reuse scheme tries to compensate for this bandwidth inefficiency in the cell-edge band by allowing cell-interior users to use this band at a much lower transmission power. However, all these schemes are static schemes, where the reuse factors are a priori fixed during the frequency planning phase.

In realistic systems, the traffic load is unlikely to be spatially homogeneous and may exhibit significant variations over time. For example, one might see concentrations of users in different regions at different times of the day, e.g. train stations, shopping districts, and lunch time. Thus the hard frequency reuse scheme, the soft frequency reuse scheme, or the usage of a centralised scheduler may not solve all of these problems that are present in a realistic system.

### SUMMARY

In general terms, the present invention proposes using a dynamically optimised frequency reuse scheme where the total power allocated to the cell-edge user group is first optimised separately in each BS, and the bandwidth to the cell-interior user group is then optimised separately in each BS. This may have the advantage(s) that:
only minimal coordination may be required between base stations and a priori frequency planning may not be required;
traffic load, characteristics of the propagation environment, and the interference vulnerabilities of users may be accounted for;
what might otherwise be a multi-cell optimisation problem may be efficiently decomposed into distributed optimisation problems, possibly resulting in single-cell resource allocation problems that need to be solved;
complexity for resource allocation may be significantly reduced;
fractional frequency reuse may be combined with the adaptive resource allocation algorithm to achieve an adaptive reuse partitioning; and/or
the network throughput may be improved while the cell-edge users may be protected from inter-cell interference.

In a first particular expression of the invention there is provided a method of communication as claimed in claim 1.

In a second particular expression of the invention there is provided a BS as claimed in claim 18.

In a third particular expression of the invention there is provided a communication network as claimed in claim 19.

In a forth particular expression of the invention there is provided a UE as claimed in claim 20.

In a fifth particular expression of the invention there is provided an integrated circuit as claimed in claim 21.

The invention may be implemented according to any of the embodiments in claims 2 to 17.

### BRIEF DESCRIPTION OF THE DRAWINGS

One or more example embodiments of the invention will now be described, with reference to the following figures, in which:

FIG. 1 is a schematic diagram of a wireless network according to an example embodiment;

FIG. 2 is a schematic diagram of a soft frequency reuse scheme;

FIG. 3 is a schematic diagram of a hard frequency reuse scheme;

FIG. 4 is a flow diagram of a method of wireless communication according to an example embodiment;

FIG. 5 is a method of partitioning the users in FIG. 4;

FIG. 6 is an alternative method of partitioning the users in FIG. 4;

FIG. 7 is a method of determining the power level for the cell-edge user group in FIG. 4;

FIG. 8 is a method of determining the bandwidth for the cell-interior user group in FIG. 4;

FIG. 9 is a schematic diagram of a simulation of the example embodiment;

FIG. 10 is a graph of the average throughput of the simulation in FIG. 9;

FIG. 11 is a graph of the 85^{th} percentile throughput of the simulation in FIG. 9; and

FIG. 12 is a graph of the 5^{th} percentile throughput of the simulation in FIG. 9.

### DETAILED DESCRIPTION

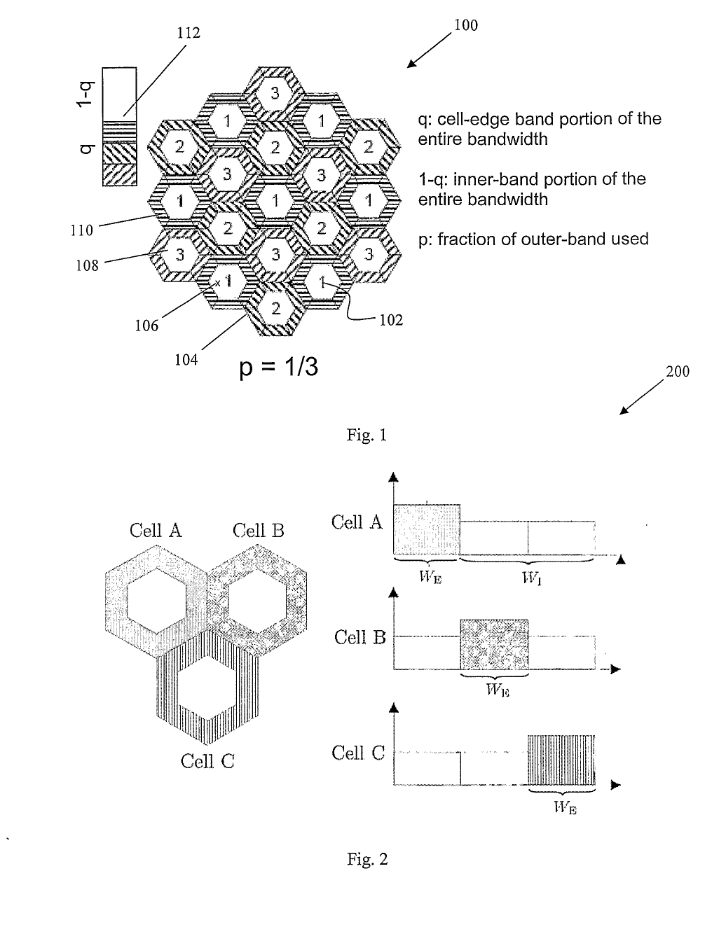

A first example embodiment of a wireless mobile communication network 100 is shown in FIG. 1. A plurality of BSs 102 are geographically distributed across the network 100. The coverage of each BS (or other NB) 102 is defined as a cell 104, where the term “cell” refers to the smallest coverage area of a BS. Users, or more specifically UEs 106, are dispersed throughout the network 100, and each UE 106 communicates via the BS 102 within that cell 104. Each cell 104 may be divided into a cell-interior 108 and a cell-edge 110. As described previously it may be desirable to allocate channels 112 to the cell-edge 110 orthogonally with those of neighbouring BSs to avoid ICI. To efficiently achieve this, the network 100 may operate as described below.

The BS 102 and the UE 106 may include an integrated circuit or processor programmed to execute the algorithms mentioned later on. The algorithms may be stored in ROM, RAM or external storage. Each BS 102 may be connected to a backbone network (not shown), which allows communication between UEs, between BSs and with other networks.

A. Network Model

We consider the downlink of a OFDMA multi-cell scenario with N cells. In each of these cells, where k ∈ [symbol] ={ 1, 2, . . . , K}. The users are divided into cell-interior and cell-edge user groups with [symbol] _{I} ⊂ [symbol] and [symbol] _{E} ⊂ [symbol] , such that [symbol] _{I} ∪ [symbol] _{E}= [symbol] , and [symbol] _{I} and [symbol] _{E} are disjoint sets. As a result, we have K=K_{I}+K_{E}, where K_{I}=| [symbol] _{I}| and K_{E}=| [symbol] _{E}|. Each BS 102 is equipped with one or more antennae and is imposed with Pₘₐₓ. The subcarriers are divided into subchannels for data transmission. Such a channelisation technique can reduce system overhead in terms of the number of feedback and control signalling required. In addition, resource allocation can be performed at the granularity of subchannels, which significantly reduces the computational and informational complexity of the scheduler. Thus, the total number of subchannels is W/B and j ⊂ [symbol] ={1, 2, . . . W/B}.

Within each cell, each user may access the channel orthogonally and the transmissions within each cell may be synchronised so that no intra-cell interference exists. Since the frequency resource is reused in other cells of the network, ICI is present and the degree of this impairment depends on the interference management scheme. In the example embodiment, it is assumed that the ICI in each cell may come from users in the neighbouring cells. The subchannels available for assignment in the cell-interior and cell-edge user groups of a cell n are chosen from the sets [symbol] _{I}⁽ⁿ⁾ and [symbol] _{E}⁽ⁿ⁾, respectively, where n ∈ [symbol] ={1, 2, . . . , N}, [symbol] _{I}⁽ⁿ⁾ ⊂ [symbol] , [symbol] _{E}⁽ⁿ⁾ ⊂ [symbol] , and [symbol] _{I}⁽ⁿ⁾ and [symbol] _{E}⁽ⁿ⁾ are chosen based on the types of frequency reuse partitioning scheme used.

In the n-th cell, the instantaneous received SINRs in the j-th subchannel for the k-th user is given by Equation (1):

$${SINR}_{jk}^{( n )} = \frac{{\vert {h}_{jk}^{( n )} \vert}^{2} {p}_{j}^{( n )}}{{\sum }_{{m ∈ N}_{m \neq n}} {\vert {h}_{jk}^{( m )} \vert}^{2} {p}_{j}^{( m )} + {N}_{0} B} \qquad ( 1 )$$

where m ∈ [symbol] .

The channel gains hⱼₖ⁽ⁿ⁾ and hⱼₖ^{(m)} are estimated by the UE. The channel parameters of the downlink channel are estimated by the UE at the granularity of subchannels i.e. the resolution used is at the subchannel level, and the channel parameters are fed back to the BS. By performing estimation at the granularity of subchannels, there may be the advantage of lower complexity as estimation will not have to be performed at the subcarrier level. Alternative embodiments can also instead estimate the channel parameters at the BS, e.g. where a BS estimates the UE's uplink channel in a Time-Division Duplexing (TDD) system and use the reciprocal property to estimate the parameters of the downlink channel. In this case, a feedback channel from the UE to the BS may not be necessary.

B. Frequency Reuse Partitioning

As mentioned previously fractional frequency reuse schemes allow more efficient use of the spectrum. In the following, the differences between soft and hard frequency reuse schemes are described in more detail.

B.1 Soft Frequency Reuse

As illustrated in FIG. 2, soft frequency reuse 200 reserves a fraction of the total system bandwidth for the cell-edge users only W_{E}=qW, where q ∈ [0,1]. Neighbouring cells are coordinated to ensure their cell-edge bands are orthogonal, such that the condition that [symbol] _{E}⁽ⁿ⁾ ∩ [symbol] _{E}^{(m)}=φ, ∀n≠m is always satisfied. The cell-interior users can then use the remaining bandwidth W_{I}=(1−q)W. Since the cell-interior bands need not be orthogonal to the neighbouring cell edge bands, we can have the condition that J_{I}⁽ⁿ⁾ ∩J_{E}^{(m)}≠Ø, ∀n≠m. Without loss of generality, we let [symbol] _{I}⁽ⁿ⁾={qW/B+1,qW/B+2, . . . , W/B} and [symbol] _{E}⁽ⁿ⁾={1, 2, . . . , qW/B}, where qW/B is an integer value. Unlike the conventional frequency reuse, the total usable bandwidth per cell for the soft frequency reuse is still W.

B.2 Hard Frequency Reuse

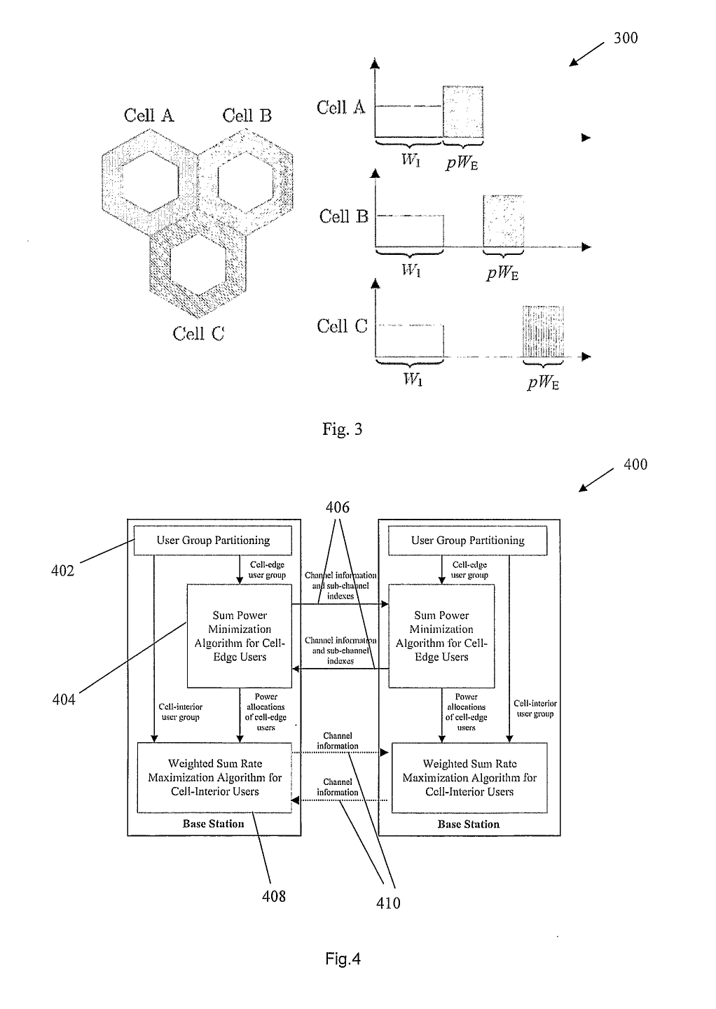

As shown in FIG. 3, the total system bandwidth is divided into the cell-interior W, and cell-edge W_{E} bands in the hard frequency reuse 300. In this specification, the term “hard frequency reuse” may also be referred to as “partial frequency reuse”. Thus, we have W_{I}=(1−q)W and W_{E}=qW. Within the cell-edge band, a reuse factor of p is employed such that the cell-edge users are only allowed to use pW_{E} in each cell. This is equivalent to the conventional frequency reuse concept, except that it is used only on the cell-edge band so that the condition that J_{I}⁽ⁿ⁾ ∩J_{E}^{(m)}=Ø and [symbol] _{E}⁽ⁿ⁾ ∩ [symbol] _{E}^{(m)}=φ, ∀n≠m is always satisfied. The cell-interior band is reserved for cell-interior group users only and has a reuse factor of 1, i.e., [symbol] _{I}⁽ⁿ⁾= [symbol] _{I}^{(m)}, ∀n, m. Without loss of generality, we let [symbol] _{I}⁽ⁿ⁾={1, 2, . . . , (1−q)W/B} and [symbol] _{E}⁽ⁿ⁾={(1−q)W/B+1, (1−q)W/B+2, . . . , [1−q(1+p)]W/B}. Thus the total usable bandwidth in each cell for hard frequency reuse is (1−q)W+qpW. When the j-th subchannel in the n-th cell belongs to [symbol] _{I}⁽ⁿ⁾, the instantaneous received SINRs for user k is given by Equation (1). On the other hand, the instantaneous received SINRs for user k in the j-th subchannel when j ∈ [symbol] _{E}⁽ⁿ⁾ is given by Equation (2):

$${SINR}_{jk}^{( n )} = \frac{{\vert {h}_{jk}^{( n )} \vert}^{2} {p}_{j}^{( n )}}{{N}_{0} B} . \qquad ( 2 )$$

C. Problem Formulation

To improve fairness between the two user groups, we may fix Rₘᵢₙ for all the cell-edge users. This minimum rate constraint may force the instantaneous rate of each cell-edge user to be at least as large as Rₘᵢₙ. The remaining resources may then be used to maximise the cell interior user group throughput. Mathematically, we can formulate this multi-cell optimisation problem in Equation (3):

$${multi}_{} \text{:} \{ \begin{matrix}{max}_{\{ {x}_{jk}^{( n )} \} , \{ {p}_{j}^{( n )} \}} & {\sum }_{n ∈ 𝒩} {\sum }_{k ∈ {𝒦}_{I}} {w}_{k}^{( n )} {R}_{I , k}^{( n )} & \\ s . t . & {R}_{E , k}^{( n )} \geq {R}_{min} , & k ∈ {𝒦}_{E} , n ∈ 𝒩 , \\ & {\sum }_{j ∈ 𝒥} {p}_{j}^{( n )} \leq {P}_{max} , & n ∈ 𝒩 , \\ & {\sum }_{k ∈ 𝒦} {x}_{jk}^{( n )} \leq 1 , & j ∈ 𝒥 , n ∈ 𝒩 , \\ & {x}_{jk}^{( n )} ∈ \{ 0 , 1 \} , & j ∈ 𝒥 , k ∈ 𝒦 , n ∈ 𝒩\end{matrix} \qquad ( 3 )$$

where xⱼₖ⁽ⁿ⁾ ∈ {0, 1} indicates whether subchannel j is used by user k or not, and where

$${R}_{I , K}^{( n )} = B {\sum }_{j ∈ {𝒥}_{I}^{( n )}} {x}_{jk}^{( n )} log ( 1 + {SINR}_{jk}^{( n )} ) and$$

$${R}_{Eκ}^{( n )} = B {\sum }_{j ∈ {𝒥}_{E}^{( n )}} {x}_{jk}^{( n )} log ( 1 + {SINR}_{jk}^{( n )} ) .$$

The objective function in [symbol] ₘᵤₗₜᵢ represents a weighted sum-rate of all cell-interior users in the system.

Even in the single-cell case and ignoring ICI, the joint subchannel and power allocation problem has been shown to be NP hard and this makes it computationally expensive to solve for [symbol] ₘᵤₗₜᵢ directly.

To avoid this, in the example embodiment the joint subchannel and power allocation problems are decoupled into sub-problems. With this approach, we still need to solve a multi-cell optimisation problem due to the presence of ICI. In the following, we propose a heuristic and suboptimal algorithm that solves [symbol] ₘᵤₗₜᵢ in a distributed manner, i.e. each cell simply solves its own optimisation problem with minimal exchange of information between the cells.

A method 400 of solving the optimisation problem is show in FIG. 4. First of all, a user group partitioning scheme partitions the users at 402. The first sub-problem for the cell-edge user group is solved using a sum power minimisation algorithm at 404. The cell-edge user group subchannel indexes are exchanged with neighbouring base stations to preserve orthogonality at 406. Optionally, other channel information such as the channel gain may also be exchanged with the neighbouring base station. The second sub-problem for the cell-interior user group is solved using a weighted sum rate maximisation algorithm at 408. At 410, the dotted lines show that the cell-interior user group channel information may optionally also be exchanged with neighbouring base stations. The optimisation is then used for transmission with the users. The optimisation may be determined iteratively on a periodic basis or may be solved continuously.

C.1 User Group Partitioning

The partitioning 402 in FIG. 4 may be implemented in a number of ways. Several example user group partitioning schemes are presented below:

C.1.1 Geometry-Based Approach

In this approach, the cell-interior and cell-edge users are differentiated based on their distances from the serving BS. This is done by using a distance threshold dₜₕ.

We assume that the system is an interference-limited system in which the thermal noise is negligible compared to the inter-cell interference. In such a case, in a linear Wyner network model, the average received signal-to-interference ratio ( S̅I̅R̅) of an arbitrary user with reuse factor 1 and located at a distance d from the serving BS can be expressed as Equation (4):

$$\overline{SIR} ( d ) = \frac{{d}^{- ɛ} {P}_{0}}{[ {( 2 R - d )}^{- ɛ} + {( 2 R + d )}^{- ɛ} ] {P}_{0}} \geq \frac{{d}^{- ɛ}}{2 {( 2 R - d )}^{- ɛ}} \qquad ( 4 )$$

where 2R is the inter-cell distance. It is assumed that all the BSs transmit at the same power P₀. Considering that the quality of service (QoS) is satisfied when the user's average SIR exceeds a given target signal-to-interference ratio value SIRₜₕ, we have the sufficiency condition of Equation (5):

$$d \leq {d}_{th} Δ \frac{2 R}{{( 2 {SIR}_{th} )}^{1 / ɛ} + 1} \qquad ( 5 )$$

The threshold distance dₜₕ can thus be defined using SIRₜₕ.

This user partitioning scheme may not be optimal since it ignores the effect of noise and temporal changes of the users' SINR distribution. However, the merit of this scheme lies in its simplicity and that no inter-cell coordination is required. To account for non-homogeneous traffic load among cells, dₜₕ has to be different for each cell by varying the SIRₜₕ for each cell.

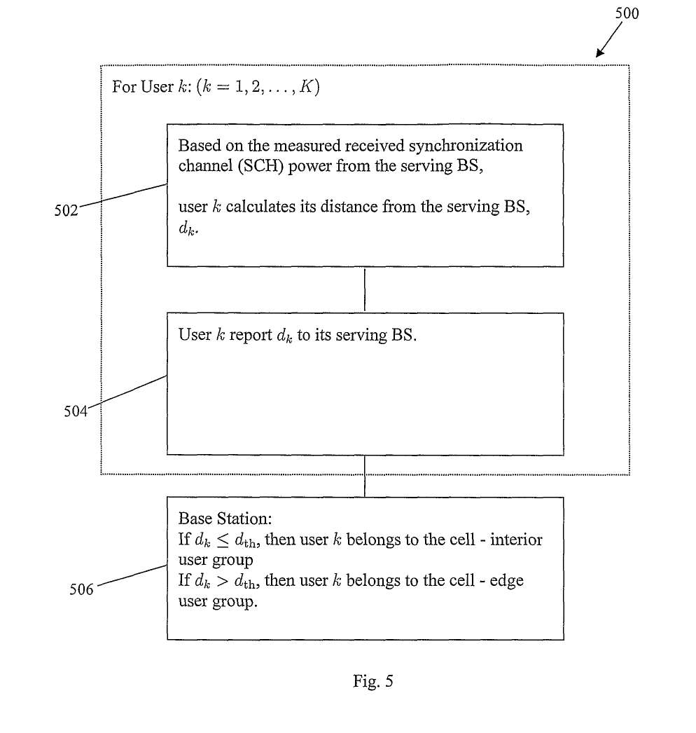

FIG. 5 shows an example geometry-based user group partitioning algorithm 500. For each user k, the distance dₖ to the serving BS is calculated at 502. For example, dₖ can be obtained using the received ranging signal sent by user k, if the ranging signal is available. Each user k then reports dₖ to the serving BS at 504. Alternatively, the BS can estimate the distance dₖ using the signal strength of a received uplink signal.

The BS then determines that user k is in the cell-edge user group of dₖ is above the distance threshold dₜₕ, or in the cell-interior user group if d_{K} is below dₜₕ at 506.

C.1.ii SINR-Based Approach

Instead of exploiting the user geometry for user group partitioning, we can use the received SINR of each user obtained from the measurements in the control channels at the serving BS. Depending on the time-scale of the control channel updates, the user group partitioning scheme can either employ the instantaneous or the average SINR values of users.

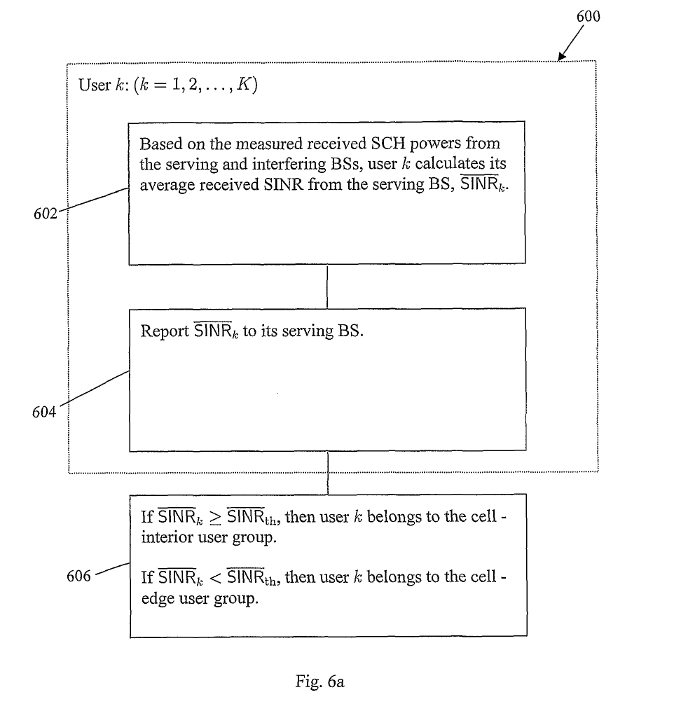

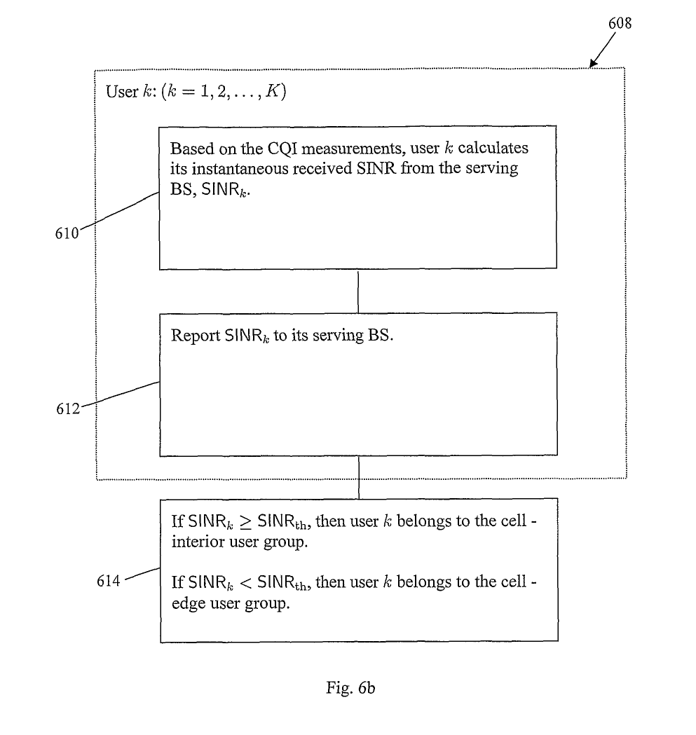

FIG. 6 shows examples of SINR-based user group partitioning algorithms 600 and 608.

C.1.ii.a. Average Case

In FIG. 6(a) using the measurement results from the synchronisation channels (SCH) from the serving BS and the interfering BSs, each user k can determine the value of its average received SINR at 602. The average received SINR information is then fed back to its serving BS at 604. When the user's average received SINR is greater than S̅I̅N̅R̅ₜₕ, the BS determines it belongs to the cell-interior user group, otherwise the BS determines it belongs to the cell-edge user group at 606.

C.1.ii.b. Instantaneous Case

In FIG. 6(b), each user in the cell determines the value of its instantaneous received SINR at 610 and feedbacks this value to its serving BS at 612. Similar to the above average case, a user is assigned to the cell-interior user group when the BS determines the received SINR is greater than the threshold SINRₜₕ, otherwise it is assigned to the cell-edge user group at 614. The S̅I̅N̅R̅ₜₕ may be larger than SINRₜₕ in order to compensate for fade margins. To obtain these instantaneous received SINRs at the serving BS, the channel quality indicator (CQI) reporting procedure may include both the channel quality and interference estimation.

C.1.iii. Fixed Ratio-Based Approach

In this approach, the serving BS first ranks the received SINRs obtained from the measurements in the control channels from largest to smallest. Instead of comparing these SINR values with some predetermined threshold value, the serving BS simply chooses the weakest users as the cell-edge users. Unlike the above two approaches, the ratio of the cell-edge to cell-interior users is fixed for this case and is chosen a priori during the cell-planning phase.

C.2. Adaptive Interference Coordination

For static interference coordination, the non-homogeneity of traffic load and varying user group distribution within each cell can be ignored to simplify the cell planning phase. However, this may lead to significant performance degradation in terms of cell and user throughput. On the other hand, adaptive interference coordination may improve system throughput as well as minimise inter-cell interference. This may increase the computational and informational complexity among the coordinated BSs. As a result, there may be a trade-off between performance gain and complexity. In the following, this trade-off may be addressed by low complexity algorithms that may combine adaptive frequency reuse and power allocation to coordinate ICI.

C.2.i Sub-Problem of Cell-Edge User Group

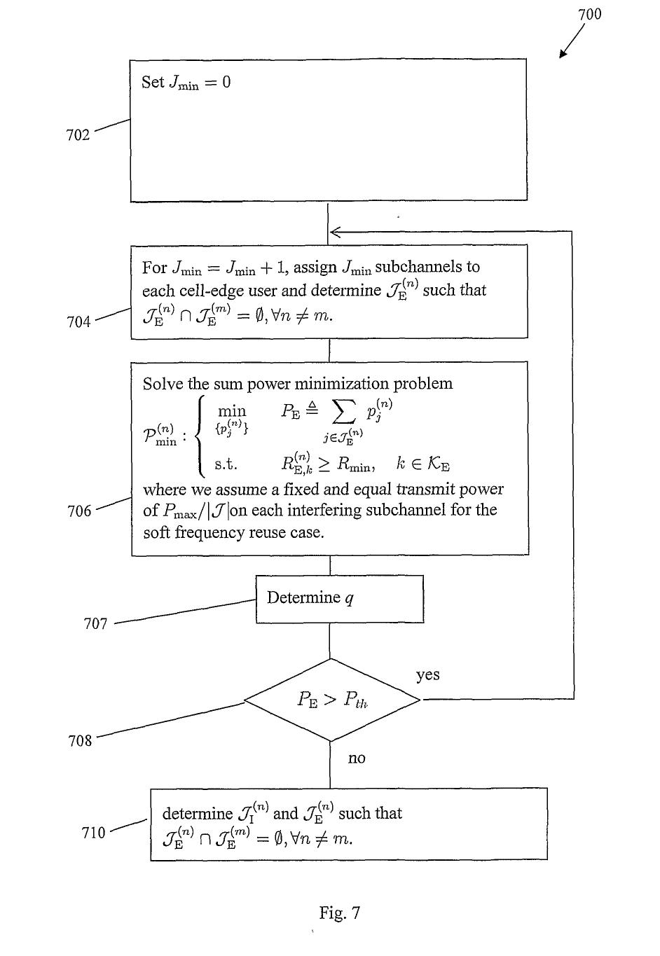

A method 700 for the optimisation of cell-edge user group is presented in FIG. 7. For the cell-edge users, frequency allocation may be carried in a fixed manner by arbitrarily assigning Jₘᵢₙ subchannels to each user in the cell-edge user group at 702 in a random manner. Alternatively, frequency allocation for the cell-edge user group may also be done based on the channel information for each user in the group.

Frequency may optionally also be allocated on a subcarrier by subcarrier basis, i.e. at a subcarrier level of granularity. Alternatively, frequency allocation may also be allocated in groups of subcarriers. The groups can, for example, comprise adjacent and/or non-adjacent subcarriers.

The allocation of frequency may optionally also be done in a two-dimensional manner, for example in terms of time-frequency resource blocks.

After the frequency allocation, the sum power minimisation problem is solved subject to a minimum rate constraint on the cell-edge users at 706. The feasibility of the sum power minimisation problem [symbol] ₘᵢₙ⁽ⁿ⁾ may depend on the minimum target rate Rₘᵢₙ and the initial subchannel allocation. Jₘᵢₙ may be increased at 704 to check the feasibility of [symbol] ₘᵢₙ⁽ⁿ⁾ as long as JₘᵢₙB≦W is satisfied.

In 707, q is determined. If there is a homogeneous user distribution over all cells, a common value of q is given by Equation (6):

$$q = \{ \begin{matrix}( {K}_{E}^{( n )} {J}_{min} B ) / W & soft frequency reuse \\ ( {K}_{E}^{( n )} {J}_{min} B ) / p W & hard frequency reuse\end{matrix} \qquad ( 6 )$$

where p can be fixed a priori during the cell-planning phase.

If there is a non-homogenous user distribution, different reuse factors can be obtained for each cell. In such a case, the number of user K_{E} varies from BS to BS and the value of q is given by Equation (7):

$$q = ( \begin{matrix}{K}_{E}^{( n )} {J}_{min} B / W & soft frequency reuse \\ ( {K}_{E}^{( n )} + {\sum }_{i = 1}^{1 / p - 1} {K}_{E}^{( m , n )} ) {J}_{min} B / p W & hard frequency reuse\end{matrix} ) \qquad ( 7 )$$

Where the frequency reuse factor is p, there would be 1/p−1 neighbouring cells amongst all the neighbouring cells for the n-th cell, such that the cell edge users for the 1/p−1 neighbouring cells would be sharing the bandwidth W_{E} (where W_{E}=qW) with the cell edge users of the n-th cell. The n-th cell and all the neighbouring 1/p−1 cells use distinct frequency bands for cell edge users (i.e. reuse factor of p in the cell edge). Taking for example hard frequency reuse scenarios where

$$p = \frac{1}{2} , p = \frac{1}{3} or p = \frac{1}{4} ,$$

q can be computed using Equation 7 to respectively be q=(K_{E}⁽ⁿ⁾+K_{E}^{(m}^{₁}^{;n)})JₘᵢₙB/pW, q=(K_{E}⁽ⁿ⁾+K_{E}^{(m}^{₁}^{;n)}+K_{E}^{(m}^{₂}^{;n)})JₘᵢₙB/pW or q+(K_{E}⁽ⁿ⁾+K_{E}^{(m}^{₁}^{;n)}+K_{E}^{(m}^{₂}^{;n)}+K_{E}^{(m}^{₃}^{;n)})JₘᵢₙB/pW.

In 708, the total power of the cell-edge user groups (P_{E}) are tested against a threshold Pₜₕ. If P_{E} is found to be greater than Pₜₕ, the optimisation process is repeated starting from 704. Pₜₕ can be selected to be a value equal to Pₘₐₓ, or it can alternatively be selected to be lower than Pₘₐₓ.

With minimal coordination between adjacent cells, we can then determine [symbol] _{I}⁽ⁿ⁾ and [symbol] _{E}⁽ⁿ⁾ for each cell at 710.

The cell-edge users may have lower SINR due to presence of ICI and significant path-loss. These users may operate in the low SINR regime and may be power limited instead of degrees of freedom limited. Thus, allocating more power to these users instead of allocating more bandwidth, may improve the rate of these cell-edge users.

C.2.ii. Sub-Problem of Cell-Interior User Group

The cell-interior users may have higher SINR since they are closer to the serving BS and farther away from the interfering BS. Thus these users may operate in a higher SINR regime, which may be a bandwidth limited regime. In this scenario, the rate of these cell-interior users may be improved by allocating more bandwidth instead of power.

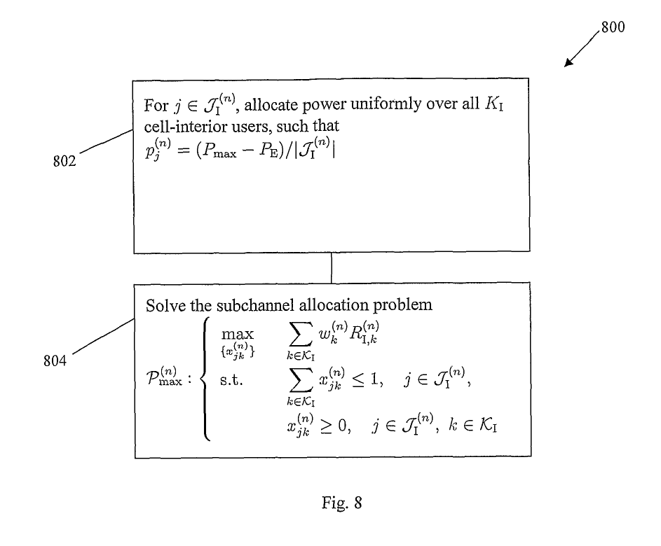

A method 800 for optimisation of cell-interior user group is presented in FIG. 8. Each subchannel (denoted by the index j) can be allocated to one UE and every UE can take on a different number of subchannels. In alternative embodiments such as where multi-user MIMO is used, each subchannel can also be allocated to and shared by more than one UE. The process of optimisation determines for each UE, how many and which subchannels will be allocated to it.

First, the residual power and bandwidth is allocated among the cell-interior users at 802. The residual transmit power is uniformly allocated over the remaining subchannels that belong to the set [symbol] _{I}⁽ⁿ⁾. Alternatively, the residual transmit power can also be non-uniformly allocated amongst subchannels.

With the power allocated, the maximum weighted sum rate problem for the cell-interior users can be solved at 804. 804 maximises the sum rate i.e. [symbol] wₖ⁽ⁿ⁾R_{I,k}⁽ⁿ⁾ given the | [symbol] _{I}⁽ⁿ⁾| subchannels that are present in [symbol] _{I}⁽ⁿ⁾. Each subchannel (denoted using the index j) of [symbol] _{I}⁽ⁿ⁾ may be allocated to a UE.

wₖ⁽ⁿ⁾ is a weighting factor for the k-th UE. wₖ⁽ⁿ⁾ represents the priority given to the UE and is usually determined according to the quality of service (QoS) requirements of the UE, as well as the type of application for the UE. wₖ⁽ⁿ⁾ can for example be determined using the queue lengths and this may have the advantage of minimising the risk of buffer overflows. Alternative embodiments can also determine wₖ⁽ⁿ⁾ using the inverse average throughput and this may have the advantage of resulting in a proportional fair scheduling policy. Other embodiments can also using an equal value of wₖ⁽ⁿ⁾ for all UEs and this would result in an equal priority for every UE.

804 also involves relaxing the integrality constraint on xⱼₖ⁽ⁿ⁾ i.e. xⱼₖ⁽ⁿ⁾ does not have to be constrained to be an integer. Typically, the integrality constraint leads to difficulty when resolving the optimisation problem and this difficulty is overcome in 804 by relaxing xⱼₖ⁽ⁿ⁾ to be a real value such that [symbol] xⱼₖ⁽ⁿ⁾≦1,j ∈ [symbol] _{I}⁽ⁿ⁾ and xⱼₖ⁽ⁿ⁾≧0,j ∈ [symbol] _{I}⁽ⁿ⁾,k ∈ [symbol] _{I}. A corresponding real valued solution is obtained and this solution can be rounded off to an integer value thereafter.

D. Simulation Results

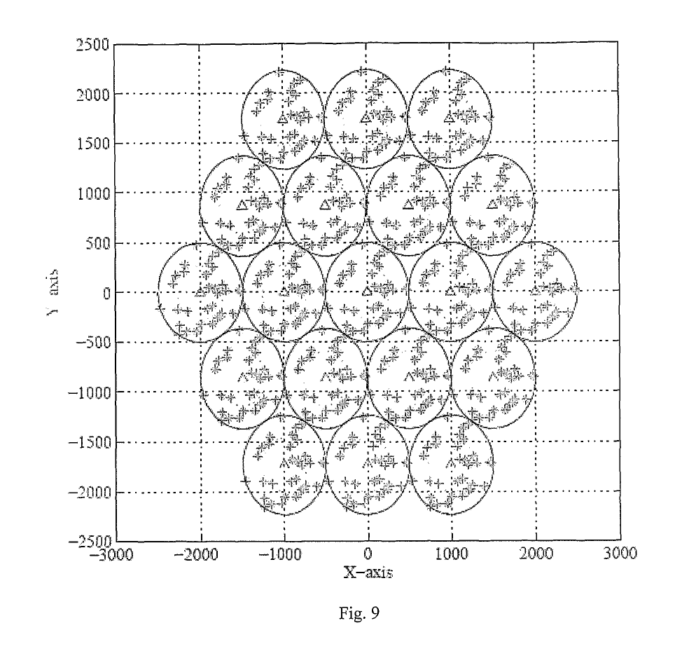

A multi-cell OFDMA downlink system with 19 cells and each cell has the same number of users uniformly distributed within the cell as plotted in FIG. 9. The OFDMA system has FFT size N=256 and the total number of users per BS is 32. The total bandwidth W=5 MHz. The distance between adjacent base stations is 1 Km. In terms of channel propagation, a path-loss model with path-loss exponent of 4 and log-normal shadowing with standard deviation of 8 dB is adopted. The baseband fast fading channel linking between i-th BS and j-th user is modelled as a finite impulse response (FIR) filter with six equally spaced taps and delay spread of 0.3. For each BS, Pₘₐₓ =60 dBm is assumed.

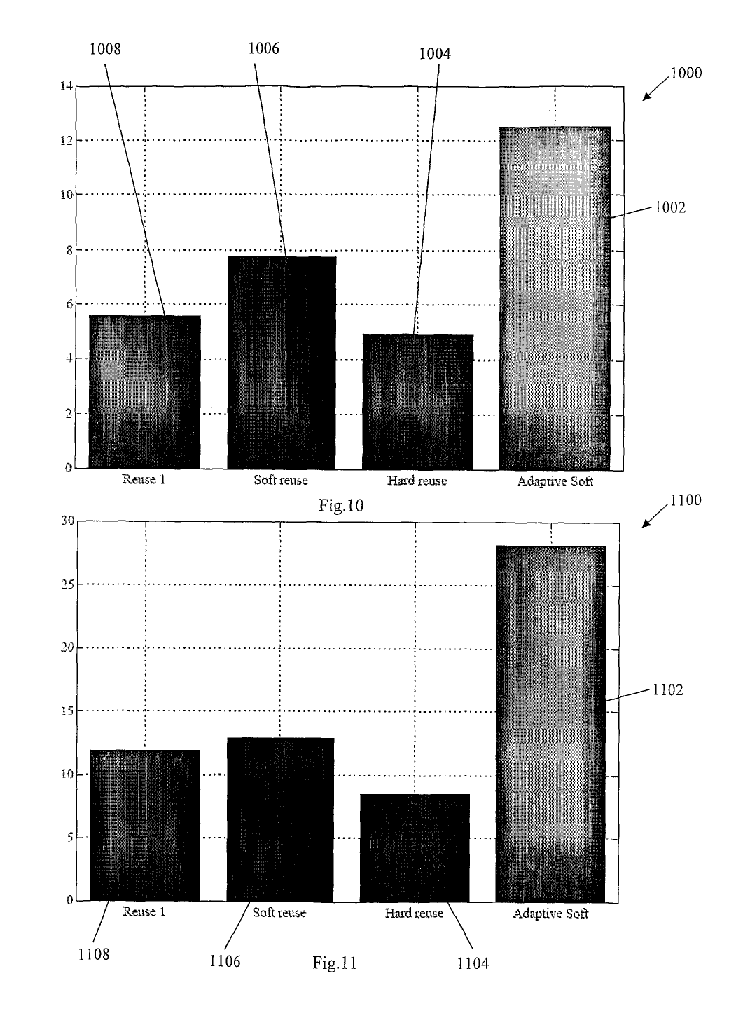

In FIGS. 10 to 12, the performance 1000, 1100, 1200 between Reuse one, Soft reuse, Hard reuse, and Adaptive soft reuse schemes are compared. The Reuse one scheme refers to a universal frequency reuse scheme with all users allocated with equal power and bandwidth. The Soft reuse scheme refers to the frequency reuse scheme of FIG. 2, with p=1/3. The Hard reuse scheme refers to the frequency reuse scheme of FIG. 3 with p=1/3 and q=0.7. The Adaptive soft reuse scheme is implemented according to the example embodiment with p=1/3 and Rₘᵢₙ=0.5. The geometry-based approach for user group partitioning is adopted for all schemes with the distance threshold dₜₕ set at 280 m. The distance threshold dₜₕ may be varied so that performance gaps between different reuse schemes is varied, since the ratio of the cell-interior to cell-edge users depends on this distance threshold.

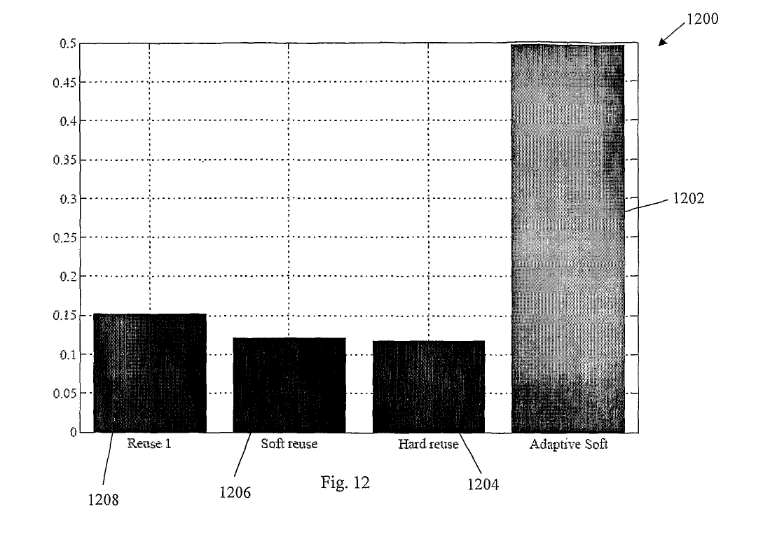

In FIG. 10 the example embodiment 1002 provides a higher average throughput at over 12, compared to the other schemes 1004, 1006 and 1008 which were all under 8. In FIG. 11 the example embodiment 1102 provides a higher 85^{th} percentile throughput at over 25, compared to the other schemes 1104, 1106 and 1108 which were all under 15. In FIG. 12 the example embodiment 1202 gives better ICI protection to the cell-edge users by maintaining a minimum rate requirement, compared to the other schemes 1204, 1206 and 1208 which were all under 0.15 for the cell-edge users. This shows that the example embodiment may be effective at optimisation with different traffic load, propagation environment characteristics, and user interference vulnerabilities.

Whilst example embodiments of the invention have been described in detail, many variations are possible within the scope of the invention as will be clear to a skilled reader. For example, while the embodiments have been illustrated using BSs with only a single hexagonal cell, sectorization can be implemented thus further splitting each cell into a few smaller cells, for example 3 or 6 smaller cells. The user equipments are also not limited by the number of antennae that they may possess and embodiments have user equipment of different numbers of antennae.

In this specification, the terms “user” and “user equipment” (or its abbreviation “UE”) have been used interchangeably. Also “subchannels” may be interchanged with “resource blocks” as maybe used in the context of 3GPP standards.

1. A method of communication comprising:
partitioning a plurality of user equipment (UE) within a cell of a base station (BS) into a cell-edge user group or a cell-interior user group,
determining a bandwidth allocation for the cell-edge user group that is orthogonal with cell-edge user groups of one or more neighbouring base stations,
determining a frequency allocation for each UE in the cell-edge user group that is orthogonal with cell-edge user groups of one or more neighbouring base stations,
determining a minimum transmit power for the cell-edge user group based on the bandwidth allocation and frequency allocation for the cell-edge user group and a predetermined minimum target rate,
determining a transmit power for each UE in the cell-interior user group based on the determined transmit power for the cell-edge user group, and
determining a frequency allocation for each UE of the cell-interior user group based on the determined transmit power for each UE in the cell-interior user group and a weighting factor.

2. The method of claim 1 wherein determining a bandwidth allocation for the cell-edge user group comprises minimising bandwidth allocation for the cell-edge user group based on a power threshold and the predetermined minimum target rate.

3. The method of claim 1 further comprising providing channel information and sub/or channel indexes to the neighbouring base stations.

4. The method of claim 1 wherein the frequency allocation for each UE in the cell-edge user group comprises allocating a subchannel to a UE of the cell-edge user group.

5. The method of claim 1 wherein the frequency allocation for each UE in the cell-edge user group is allocated at a subcarrier level of granularity.

6. The method of claim 1 wherein the frequency allocation for each UE in the cell-edge user group allocates a time-frequency resource block to the UE.

7. The method of claim 1 wherein the frequency allocation for each UE in the cell-edge user group is allocated randomly.

8. The method of claim 1 wherein the frequency allocation for each UE in the cell-edge user group is allocated based on a channel information for each UE.

9. The method of claim 1 wherein the partitioning the plurality of UE is selected from the group consisting of:
a distance threshold test;
an averaged SINR threshold test;
an instantaneous SINR threshold test; and
a fixed ratio.

10. The method of claim 2, wherein the determining a minimum transmit power for the cell-edge user group further comprises:
comparing a total power of the cell-edge user group against the power threshold of the BS; and
if the minimum transmit power is greater than the power threshold of the BS:
determining a new bandwidth allocation with an increased bandwidth for the cell-edge user group that is orthogonal with cell-edge user groups of one or more neighbouring base stations;
re-determining the minimum transmit power for the cell-edge user group based on the new bandwidth allocation for the cell-edge user group and a predetermined minimum target rate.

11. The method of claim 10 wherein the determining a minimum transmit power comprises:
$${min}_{( n )}^{} \text{:} \{ \begin{matrix}{min}_{\{ {p}_{j}^{( n )} \}} & {P}_{E} {Δ}_{=} {\sum }_{j ∈ {𝒥}_{E}^{( n )}} {p}_{j}^{( n )} \\ s . t . & {R}_{E , k}^{( n )} \geq {R}_{m i n} , k ∈ {𝒦}_{E} .\end{matrix} \qquad$$

12. The method of claim 2 further comprising determining the power threshold based on a maximum power of the BS.

13. The method of claim 1 further comprising determining the weighting factor according to a predetermined quality of service for each UE.

14. The method of claim 1 further comprising determining the weighting factor according to an inverse average throughput for each UE.

15. The method of claim 1 further comprising determining the weighting factor that is equal for all UE in the cell-interior user group.

16. The method of claim 13 wherein the determining a frequency allocation for each UE of the cell-interior user group comprises:
$${max}_{( n )}^{} \text{:} \{ \begin{matrix}{max}_{\{ {x}_{jk}^{( n )} \}} & {\sum }_{k ∈ {𝒦}_{I}} {w}_{k}^{( n )} {R}_{I , k}^{( n )} & \\ s . t . & {\sum }_{k ∈ {𝒦}_{I}} {x}_{jk}^{( n )} \leq 1 , & j ∈ {𝒥}_{I}^{( n )} , \\ & {x}_{jk}^{( n )} \geq 0 , & j ∈ {𝒥}_{I}^{( n )} , k ∈ {𝒦}_{I} .\end{matrix}$$

17. The method of claim 1 wherein [symbol] _{E}⁽ⁿ⁾ ∩ [symbol] _{E}^{(m)}=φ,∀n≠m.

18. A base station (BS) configured to communicate with a plurality of user equipment (UE) according to the method of claim 1.

19. A communications network configured to communicate according to the method of claim 1.

20. A user equipment (UE) configured to communicate with a base station (BS) according to the method of claim 1.

21. An integrated circuit or processor including stored instructions, the instructions when executed control communication between a base station (BS) and a user equipment (UE) according to the method of claim 1.
